(19) United States
(12) Patent Application Publication
(10) Pub. No.: US 2026/0278841 A1
(43) Pub. Date: Sep. 17, 2026

(54) MULTI-SENSOR EXTRINSIC CALIBRATION AND FIDUCIAL TARGET THEREFOR

(71) Applicant: The Regents of the University of Michigan, Ann Arbor, MI (US)

(72) Inventors: Steven KARAMIHAS, Ann Arbor, MI (US); Arpan KUSARI, Ann Arbor, HI (US); Mark GILBERT, Ann Arbor, MI (US)

(21) Appl. No.: 19/568,582

(22) Filed: Mar. 16, 2026

Related U.S. Application Data
(60) Provisional application No. 63/772,127, filed on Mar. 14, 2025.

(51) Int. Cl. G06T 7/80

(52) U.S. Cl. CPC G06T 7/80; G06T 2207/30204

(57) ABSTRACT

A method and system for multi-sensor extrinsic calibration. The system includes: one or more fiducial targets, wherein each fiducial target has a sensor return portion comprised of three orthogonal surfaces, and wherein each orthogonal surface of the three orthogonal surfaces is orthogonal to both other orthogonal surfaces and displays a visual indicator configured to be detected by at least one of the two or more calibratable sensors; and a processing subsystem comprised of at least one processor and memory storing computer instructions; wherein the processing subsystem, when executing the computer instruction using the at least one processor, causes the multi-sensor extrinsic calibration system to: obtain sensor data pertaining to at least one of the one or more fiducial targets from each of two or more calibratable sensors of a different sensor type; and determine calibration information based on the sensor data from the two or more calibratable sensors.

### GOVERNMENT FUNDING

This invention was made with government support under 693JJ9-21-D-000016 awarded by the U.S. Department of Transportation. The government has certain rights in the invention.

### TECHNICAL FIELD

This disclosure relates to extrinsic calibration of multiple sensors and fiducial targets used therefor and, more particularly, to extrinsic calibration of sensors of different sensor types (e.g., radar, lidar, camera) used for identifying objects or aspects of an environment.

### BACKGROUND

Modern passenger vehicles and other mobile platforms increasingly employ multiple heterogeneous sensors—such as cameras, radar sensors, lidar sensors, and inertial sensors—to perceive the surrounding environment and support functions including advanced driver assistance systems (ADAS), autonomous driving, mapping, and navigation. In order to effectively utilize data from these sensors, it is necessary to determine the spatial relationship between each sensor and a common reference frame associated with the vehicle. This process, commonly referred to as extrinsic calibration, establishes the relative position and orientation of each sensor with respect to the vehicle coordinate frame so that measurements captured in individual sensor coordinate frames may be transformed into a shared coordinate system.

In conventional extrinsic calibration approaches, data is collected from a vehicle or other sensor platform while the platform is positioned at multiple locations and orientations relative to one or more calibration targets whose locations are known. During this process, the vehicle is maneuvered so that the sensors observe the calibration targets from a variety of viewing angles and distances. Simultaneously, the pose of the vehicle—namely its position and orientation in space—is measured using a high-accuracy positioning system, such as a commercially available inertial navigation system (INS), often integrated with a global navigation satellite system (GNSS). The INS/GNSS system provides a time-synchronized estimate of the vehicle pose during sensor data acquisition.

Sensor observations of the calibration targets are then analyzed in conjunction with the measured vehicle pose and the surveyed positions of the targets. Through this analysis, mathematical relationships between the coordinate frame of each sensor and the vehicle coordinate frame may be determined. These relationships are typically expressed as transformation matrices, which define the rotational and translational offsets between the sensor coordinate frames and the vehicle coordinate frame. Once determined, these transformation matrices enable sensor measurements to be converted from the local sensor coordinate frame into the vehicle coordinate frame, thereby completing the extrinsic calibration.

Although such approaches can produce accurate calibration results, they may require significant setup effort and controlled calibration procedures. For example, the calibration targets must typically be surveyed to determine their positions, and the vehicle must be driven through multiple orientations relative to the targets while maintaining accurate pose estimation through the INS or other navigation system. Furthermore, when multiple sensor types are present, each sensor must be capable of reliably detecting the calibration targets so that corresponding observations can be obtained. These requirements can complicate calibration procedures and increase the time and resources required to perform extrinsic calibration of a multi-sensor vehicle platform.

Accordingly, there remains a need for improved systems and methods that facilitate efficient and reliable extrinsic calibration of multiple sensors on a vehicle or other mobile platform, particularly in situations where sensors of different modalities must be calibrated simultaneously using common reference targets.

### SUMMARY

In accordance with a first aspect of the invention, there is provided a multi-sensor extrinsic calibration system. The system includes: one or more fiducial targets, wherein each fiducial target of the one or more fiducial targets has a sensor return portion comprised of three orthogonal surfaces, and wherein each orthogonal surface of the three orthogonal surfaces is orthogonal to both other orthogonal surfaces and displays a visual indicator configured to be detected by at least one of the two or more calibratable sensors; and a processing subsystem comprised of at least one processor and memory storing computer instructions; wherein the processing subsystem, when executing the computer instruction using the at least one processor, causes the multi-sensor extrinsic calibration system to: obtain sensor data pertaining to at least one of the one or more fiducial targets from each of two or more calibratable sensors of a different sensor type; and determine calibration information based on the sensor data from the two or more calibratable sensors.

According to various embodiments, this system of the first aspect may further include any one of the following features or any technically feasible combination of some or all of these features:

each orthogonal surface of the three orthogonal surfaces is coupled to both other orthogonal surfaces;

the two orthogonal surfaces all are coupled to each other so as to form a common corner whereat the three orthogonal surfaces meet;

the two or more calibratable sensors include a camera and at least one of a lidar unit and a radar unit;

wherein the two or more calibratable sensors include at least three sensors, and wherein the at least three sensors include a camera, a lidar unit, and a radar unit;

the at least one fiducial target is oriented so as to face a sensor capture location for a mobile platform carrying the three calibratable sensors;

the three orthogonal surfaces form a corner of a virtual cube;

the at least one fiducial target is oriented so that a vector originating from the corner and extending along a body diagonal of the virtual cube is directed toward the sensor capture location for the mobile platform;

for each fiducial target of the one or more fiducial targets, the visual indicator of each of the three orthogonal surfaces is different than the visual indicator of both other orthogonal surfaces of the fiducial target;

the sensor data from each calibratable sensor of the two or more calibratable sensors is captured simultaneously;

the calibration information is used for performing extrinsic calibration for the two or more calibratable sensors;

each calibratable sensor of the two or more calibratable sensors is configured to capture sensor information used as a part of a multi-modal sensor system;

the two or more calibratable sensors and the multi-modal sensor system are carried by an autonomous vehicle, other vehicle, or other mobile sensor platform;

the multi-modal sensor system is configured to fuse the sensor data from the two or more calibratable sensors;

the two or more calibratable sensors have an overlapping field of view and are configured to capture data simultaneously; and/or

the visual indicator is configured to be detected by each of the two or more calibratable sensors.

In accordance with a second aspect of the invention, there is provided a method of obtaining calibration information for one or more calibratable sensors as a result of extrinsic calibration using a fiducial target. The fiducial target has a sensor return portion comprised of three orthogonal surfaces, wherein each orthogonal surface of the three orthogonal surfaces is orthogonal to both other orthogonal surfaces and displays a visual indicator configured to be detected by at least one of the two or more calibratable sensor. The method includes the steps of: obtaining sensor data pertaining to at least one of the one or more fiducial targets from each of two or more calibratable sensors of a different sensor type; and determining calibration information based on the sensor data from the two or more calibratable sensors.

According to various embodiments, the method of the second aspect of the invention may further include any one of the features discussed in connection with the first aspect of the invention.

In accordance with a third aspect of the invention, there is provided a fiducial target for use in extrinsic calibration of two or more calibratable sensors. The fiducial target includes: a sensor return portion comprised of three orthogonal surfaces, wherein each orthogonal surface of the three orthogonal surfaces is orthogonal to both other orthogonal surfaces and displays a visual indicator configured to be detected by at least one of the two or more calibratable sensors.

According to various embodiments, the fiducial target of the third aspect of the invention may further include any one of the features discussed in connection with the first or second aspects of the invention and/or any of the following features or any technically-feasible combination of some or all of these features:

the visual indicator is an AprilTag, quick-response (QR) code, or other graphic whose orientation is detectable; each orthogonal surface of the three orthogonal surfaces is coupled to both other orthogonal surfaces;

the two orthogonal surfaces all are coupled to each other so as to form a common corner whereat the three orthogonal surfaces meet;

further comprising a global navigation satellite system (GNSS) antenna co-located with the sensor return portion at least during an initial position measurement operation;

the surface area of each surface of the three or more orthogonal surfaces is at least one square foot; and/or

the surface area of each surface of the three or more orthogonal surfaces is at least three square feet.

According to various embodiments, the system of the first aspect of the invention and the method of the second aspect of the invention may further include any one of the features discussed in connection with the third aspect of the invention.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting a multi-sensor extrinsic calibration system having one or more fiducial targets, a plurality of calibratable sensor, and a processing subsystem, according to one embodiment;

FIG. 2 is a block diagram depicting a multi-sensor extrinsic calibration system having a plurality of fiducial targets, a plurality of calibratable sensors, and a processing subsystem, according to one embodiment;

FIG. 3 depicts a diagrammatic isometric view of a multi-sensor extrinsic calibration environment that may be used with the embodiments of FIGS. 1 and 2, according to one embodiment;

FIGS. 4 and 5 each depict a top-down, plan, diagrammatic view (in the X-Y plane as depicted, considered level to earth / perpendicular to gravity) of the multi-sensor extrinsic calibration environment of FIG. 3, according to one embodiment;

FIG. 6 is a first perspective view of fiducial target having a post mounted to the ground, according to one embodiment;

FIG. 7 is a second perspective view of the fiducial target of FIG. 6, according to one embodiment; and

FIG. 8 is a flowchart of a method for obtaining calibration information for one or more calibratable sensors as a result of extrinsic calibration using a fiducial target, according to one embodiment.

### DETAILED DESCRIPTION

A system and method for calibrating or enabling calibration of multiple sensors using a common fiduciary target is provided, as is a fiducial target for such extrinsic calibration. More particularly, the system, referred to also as a multi-sensor extrinsic calibration system, includes a plurality of sensors to be calibrated (referred to also as the “calibratable sensors”), a processing subsystem for executing the method, and the common fiduciary target, which is comprised of three orthogonal planar surfaces, each of which has a visual indicator such as an AprilTag™ or quick-response (QR) code, for example. Position and pose of the common fiducial target may be determined initially through use of global navigation satellite system (GNSS) techniques, such as through use of a real-time kinematics (RTK) base station and corresponding antenna system located at the common fiducial target during this initial position measuring operation. The processing subsystem then obtains sensor data from each of the calibratable sensors, and then uses the sensor data to extrinsically calibrate the calibratable sensors through use of known position and orientation (at sensor capture time) of a sensor platform (to which the sensor is fixedly connected) and known position and orientation of the fiducial targets (at sensor capture time). The result of the extrinsic calibration results in calibration information used for calibrating the calibratable sensors.

The fiducial targets, at least in some embodiments, are fixed to the earth, and so the position and orientation of such targets may be determined and known ahead of time through use of the initial position measuring operation. This initial position measuring operation is used when the fiducial target is first deployed to a particular position, and may include placing a GNSS antenna at the same location as the fiducial target, measuring the GNSS location thereof, and recording the GNSS location as the location for the fiducial target. Of course, a known or pre-measured position offset may be applied between the GNSS antenna and the corresponding fiducial target, as appropriate depending on the relative positioning between the antenna and the fiducial target.

As used herein, when the position and orientation of a fiducial target is referred to, such reference is made with respect to an identifiable, pre-known point of the fiducial target, such as the nexus point between the three orthogonal surfaces of the fiducial target (the nexus point here referring to an origin point of a body diagonal of a cube (or virtual cube) like structure with three of its walls corresponding to a different side of the fiducial target). Furthermore, although the depicted embodiments discussed below are made with regard to fiducial targets of a corner-cube design in which three orthogonal surfaces are arranged as three adjacent sides of a cube (see, e.g., FIG. 7), it will be appreciated that other such designs employing substantially orthogonal surfaces may be used, whereby the term “generally orthogonal”, when used in connection with a surface relative to another surface, refers to a disposition in which the surface is disposed at an angle of no more than 120 degrees and no less than 60 degrees.

Extrinsic calibration involves determining the relative position and orientation between different sensors on a common platform, such as a vehicle. This process is particularly challenging when the sensors are mounted on a moving platform, such as an autonomous vehicle. When the sensors are carried by a moving platform, such as an autonomous vehicle, the calibration process must account for the vehicle’s motion. This involves capturing data from the sensors while the vehicle is in motion and using algorithms to compensate for the movement. The calibration process typically involves collecting data from multiple positions and orientations to ensure robustness and accuracy. Advanced optimization techniques may be employed to minimize the error between the observed and predicted positions of the calibration target features, resulting in precise transformation parameters that align the sensors’ coordinate frames.

Nonetheless, one of the challenges in extrinsic calibration is addressing movement of the sensors as a result of movement of the platform or apparatus it is attached or connected to (referred to as a sensor platform). According to aspects discussed herein, embodiments involves enabling the simultaneous capturing of sensor data through the use of a calibration target that is detectable by multiple sensors, such as radar, lidar, and vision systems. Furthermore, according to embodiments, this is addressed by using a fiducial target (a calibration target) that can provide reliably detectable features for all various sensor technologies involved in the calibration. Particularly, in connection with autonomous vehicles (AVs) AVs, for example, cameras, radar sensors, and lidar sensors are often used concurrently to capture data of the environment; this data is often fused and used for AV operations, such as driver notifications, trajectory determinations, etc. According to embodiments, there is provided a fiducial target, also called a calibration target, that is designed and configured to reflect radar signals, generate distinct lidar points, and present identifiable visual features, thereby enabling simultaneous capturing of sensor data from all three different-type sensors.

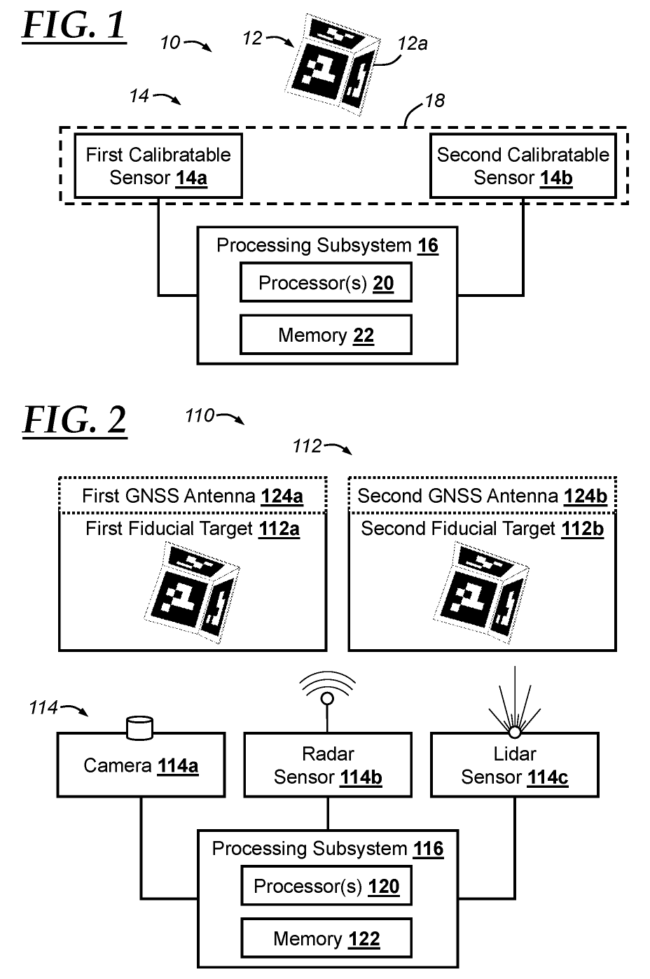

With reference to FIG. 1, there is shown a multi-sensor extrinsic calibration system 10 having one or more fiducial targets 12, a plurality of calibratable sensor 14 (including a first calibratable sensor 14a and a second calibratable sensor 14b), and a processing subsystem 16. The multi-sensor extrinsic calibration system 10 may be incorporated and/or configured as a part of one or more larger systems or devices, such as of an autonomous vehicle (AV), for example. Furthermore, in embodiments, the first calibratable sensor 14a and the second calibratable sensor 14b are each fixed relative to one another, such as each being fixed relative to a vehicle chassis, for example. In other embodiments, the plurality of calibratable sensors 14 includes three or more calibratable sensors.

The one or more fiducial targets 12 includes a first fiducial target 12a, as shown in FIG. 1. The discussion of the first fiducial target 12a is hereby incorporated and attributed to each of the other fiducial targets discussed herein. In at least one embodiment, the fiducial target 12a is co-located with a GNSS antenna (referred to as a fiducial target GNSS antenna) that is used to determine the position of the fiducial target 12a and, in other embodiments, other precise location determining means may be used. Here, the fiducial target 12a is co-located with the GNSS antenna at least during an initial position measuring operation during which the precise position of the fiducial target is determined; after such a process, the GNSS antenna may be removed; however, such location determining means may be redeployed for execution of a follow-up position measuring operation to ensure that the fiducial target’s position had not changed (or if it did, how) since the initial position measuring operation. Each of the fiducial targets 12 may be a mobile fiducial target (e.g., a unmanned aerial vehicle (UAV)) or a fixed fiducial target. A fixed fiducial target is one that is fixed relative to earth, and a mobile fiducial target is a fiducial target that is not a fixed fiducial target.

The plurality of calibratable sensors 14 includes at least the first calibratable sensor 14a and the second calibratable sensor 14b. Each calibratable sensor of the calibratable sensors 14 is a remote view sensor. As used herein, a remote view sensors is a sensor designed or configured to detect an object’s location, position, and/or orientation. Examples of a remote view sensor includes a camera (a visible light camera), a radar sensor, and a lidar sensor.

The plurality of calibratable sensors 14 are disposed on or otherwise physically coupled or attached to a sensor platform 18. As used herein, a “sensor platform”, when used in connection with one or more sensors, includes various structures used for physically coupling to each of the one or more sensors, including those having one or more surfaces or other attachment points for the one or more sensors to be physically attached.

In at least some embodiments, the sensor platform is a vehicle, such as an AV, or a portion thereof. For example, many AVs have multiple sensors for sensing aspects of its environment, including, for example, cameras, radar sensors, and lidar sensors. Each of these sensors is considered to be attached to the sensor platform (here, the AV) and, in embodiments, are each fixed to the sensor platform and each may be, thus, held in a fixed position relative to other sensors attached to the sensor platform. In some embodiments, the sensor platform includes multiple portions, including a first portion and a second portion, where the first portion is moveable relative to the second portion, and where the first portion includes a first calibratable sensor and the second portion include a second calibratable sensor. Movement of the respective first and second portions relative to one another is known by the processing subsystem 16 and used for operation of the sensor platform or system incorporating or operating with the sensor platform. Furthermore, although the processing subsystem 16 is not shown as being physically coupled to the sensor platform 18 and only the calibratable sensors 14 are shown as being physically coupled to the sensor platform 18, in other embodiments, the processing subsystem 16 is physically coupled to the sensor platform 18, such as being a controller or other electronic control unit (ECU) of the vehicle, for example.

The processing subsystem 16 is used for executing the method discussed herein or at least portions thereof, according to embodiments. The processing subsystem 16 includes at least one processor 20 and memory 22. The processing subsystem 16 may include one or more local and/or remote (e.g., cloud-based) computers or controllers, according to embodiments. The at least one processor 20 refers to one or more electronic processors. Any one or more of these processors or other processors discussed herein may be implemented as any suitable electronic hardware that is capable of processing computer instructions and may be selected based on the application in which it is to be used. Examples of types of processors that may be used include central processing units (CPUs), graphics processing units (GPUs), field-programmable gate arrays (FPGAs), application specific integrated circuits (ASICs), microprocessors, microcontrollers, etc.

The memory 22 refers to one or more non-transitory, computer-readable memory devices (or memories), and any of these memories or other memory discussed herein may be implemented as any suitable type of memory that is capable of storing data or information in a non-volatile manner and in an electronic form so that the stored data or information is consumable by the processor. The memory may be any of a variety of different electronic memory types and may be selected based on the application in which it is to be used. Examples of types of memory that may be used include magnetic or optical disc drives, ROM (read-only memory), solid-state drives (SSDs) (including other solid-state storage such as solid-state hybrid drives (SSHDs)), other types of flash memory, hard disk drives (HDDs), non-volatile random access memory (NVRAM), etc. It will be appreciated that the computers may include other memory, such as volatile RAM that is used by the processor, and/or multiple processors.

The memory 22 serves as a local data store for storing the computer instructions, but may also be used for storing various data obtained or generated by the multi-sensor extrinsic calibration system 10. A “data store” or “electronic data store” refers to any data storage platform, such as cloud storage services like Amazon S3™ or Google Drive™, relational databases like MySQL™ or PostgreSQL™, and NoSQL databases like MongoDB™ or Cassandra™, that is designed for storing data in a manner accessible by electronic processing systems. This includes any repository that allows for the organization, management, and retrieval of data through digital means, enabling efficient data handling, analysis, and processing by computers and other electronic devices. This electronic data store could take the form of a cloud database, such as Amazon’s DynamoDB™, which offers seamless scalability and performance. Alternatively, for structured data and frequent queries, a relational database like MySQL™ or PostgreSQL™ could be employed. If the data is unstructured or semi-structured and comes in large volumes, NoSQL databases such as MongoDB™ or Apache Cassandra™ might be more suitable. For data that is time-series in nature, time-series databases like InfluxDB™ or TimescaleDB™ could provide efficient storage and query capabilities. For large-scale data analysis, data warehousing solutions such as Google BigQuery™, Amazon Redshift™, or Snowflake™ can be used. In cases where fast data access is paramount, in-memory databases like Redis™ or Memcached™ could be employed. Lastly, for storing large volumes of raw data, distributed file systems like Hadoop HDFS™ or cloud-based solutions like Amazon S3™ could be used. The choice of data store would ultimately depend on the specific requirements of the system handling the data.

The multi-sensor extrinsic calibration system 10 may be implemented using a variety of different processing techniques, including use of cloud computing frameworks and services, such as those offering real-time data streaming and processing, such as Amazon Web Services (AWS) Kinesis™, for example. In other embodiments, local computers or processing machines may be used for the hardware of the processing subsystem 16.

With reference now to FIG. 2, there is shown a multi-sensor extrinsic calibration system 110 having a plurality of fiducial targets 112 (including a first fiducial target 112a and a second fiducial target 112b), a plurality of calibratable sensors 114 (including a first calibratable sensor or camera 114a, a second calibratable sensor or radar sensor 114b, and a third calibratable sensor or lidar sensor 114c), and a processing subsystem 116. The multi-sensor extrinsic calibration system 110 may include a sensor platform to which the plurality of calibratable sensors 114 are physically attached. The processing subsystem 116 includes at least one processor 120 and memory 122. The components 110-122 of the multi-sensor extrinsic calibration system 110 are similar to components 10-22 of the multi-sensor extrinsic calibration system 10 of FIG. 1, and that discussion of those components 10-22 is hereby incorporated and attributed to like component 110-122 (where like names and/or a difference of 100 between reference numerals of components of FIG. 2 and FIG. 1 indicates correspondence; e.g., the processing subsystem 116 corresponds to the processing subsystem 16).

In the embodiment of FIG. 2, each of the first fiducial target 112a and the second fiducial target 112b is co-located with a respective global navigation satellite system (GNSS) antenna 124a, 124b. The GNSS antenna 124a, 124b of each of the fiducial targets 112a, 112b is shown with a dotted border, indicating here that the GNSS antenna 124a,124b need not be present after the initial position measurement operation in which the absolute (relative to earth) location of the fiducial target 112a, 112b is determined.

Although not shown in FIG. 2, the calibratable sensors 114 may be installed and/or otherwise attached to a sensor platform, such as the sensor platform 18. In embodiments, the calibratable sensors 114 are installed on a vehicle as a part of the vehicle’s vehicle electronics and are, thus, carried with the vehicle.

In one embodiment, the calibratable sensors 114 are installed on a vehicle as a part of a multi-modal sensor system, which is a system that takes sensor data of different sensor types (e.g., radar, lidar, camera) and then fuses the sensor data so as to make informed decisions that are all aligned in terms of their reference plane or point(s). Such multi-modal sensor systems may be a part of a larger AV control process and performed by an AV controller and/or other controllers of the vehicle. Of course, the calibratable sensors 114 may be used in other applications as well, according to embodiments.

The camera 114a is used to obtain image data of one or more objects within the environment, which can include color information of one or more objects. The camera 114a can be any suitable digital camera. According to at least some embodiments, the camera 114a includes a processor and memory separate from the processor 120 and memory 122; however, in some embodiments, the camera 114a and the processing subsystem 116 may share a common processor and/or memory. Also, although only a single camera 114a is shown and described, it will be appreciated that, according to some embodiments, each sensor package 20,120 includes a plurality of cameras.

The radar sensor 114b is used to obtain radar sensor data of one or more objects within the environment, which can include information such as the velocity, range, and position of those objects. The radar sensor 114b emits radio waves that reflect off of objects and then receives the reflected signals to determine object characteristics. The radar sensor 114b can be any suitable radar device, including, for example, short-range, mid-range, and long-range radar systems. According to at least some embodiments, the radar sensor 114b includes a processor and memory separate from the processor 120 and memory 122; however, in some embodiments, the radar sensor 114b and the processing subsystem 116 may share a common processor and/or memory.

An example of a real radar sensor that can be used for an autonomous vehicle (AV) is the Continental ARS 540. The ARS 540 is a long-range radar sensor designed specifically for automotive applications, particularly for advanced driver assistance systems (ADAS) and autonomous driving. This radar operates at 77GHz and provides high-resolution detection of objects up to 300 meters away, and can detect the position, speed, and trajectory of vehicles, pedestrians, and other obstacles in the environment, enabling precise object tracking and collision avoidance. Additionally, the ARS 540 uses multiple radar beams to create a wide field of view, which is essential for safe autonomous vehicle operation.

The lidar sensor 114c is used to obtain lidar sensor data of one or more objects within the environment, which can include range and position information of those objects. The lidar sensor 114c emits non-visible light waves that reflect off of objects and then receives the reflected waves to determine object characteristics. Various types of lidar sensors may be used, including, for example, those manufactured by Velodyne™, such as the Alpha Prime™, the Ultra Puck™, and the Puck™. According to at least some embodiments, the lidar sensor 114c includes a processor and memory separate from the processor 120 and memory 122; however, in some embodiments, the lidar sensor 114c and the processing subsystem 116 may share a common processor and/or memory.

The GNSS antennas 124a and 124b are used to receive GNSS signals transmitted by a constellation of GNSS satellites, and a corresponding GNSS receiver or processor (referred to as a GNSS receiver) is used for processing the received GNSS signals in order to determine a position thereof. These receivers include hardware enabling them to acquire and process GNSS data, which provides location and time information. Each GNSS antenna 124a, 124b may be positioned externally to the housing of the receiver. In some embodiments, the GNSS receiver(s) for the GNSS antennas 124a, 124b may be (or each be) a global positioning system (GPS) receiver that receive signals from the United States’ GPS satellite system. Alternatively, these receivers can be compatible with other global navigation satellite systems, such as GLONASS or Europe’s Galileo system.

The GNSS receiver(s) for the GNSS antennas 124a and 124b utilize the received GNSS signals to determine the geographical position of the device at a specific time. In some embodiments, the position may be determined using a real-time kinematic (RTK) GNSS process, which improves positional accuracy by utilizing signals from an RTK base station. The enhanced accuracy provided by RTK GNSS is particularly useful when sensor data from different systems needs to be merged. Additionally, the GNSS antennas 124a, 124b can be integrated with an inertial measurement unit (IMU) to determine the orientation of the system relative to gravity, which aids in merging sensor data from multiple sources.

The GNSS data, the camera sensor data, radar sensor data, lidar sensor data, other sensor data, and/or other information determined by or obtained at the multi-sensor extrinsic calibration system 110 is stored in the memory 122 of the processing subsystem 116. The processing subsystem 116 obtains the sensor data via a local connection between the corresponding sensor 114a-c and the processor(s) 120; however, in other embodiments, it is possible for sensor data via a remote connection, such as where the sensor data is streamed to cloud storage and then accessed by the processing subsystem 116.

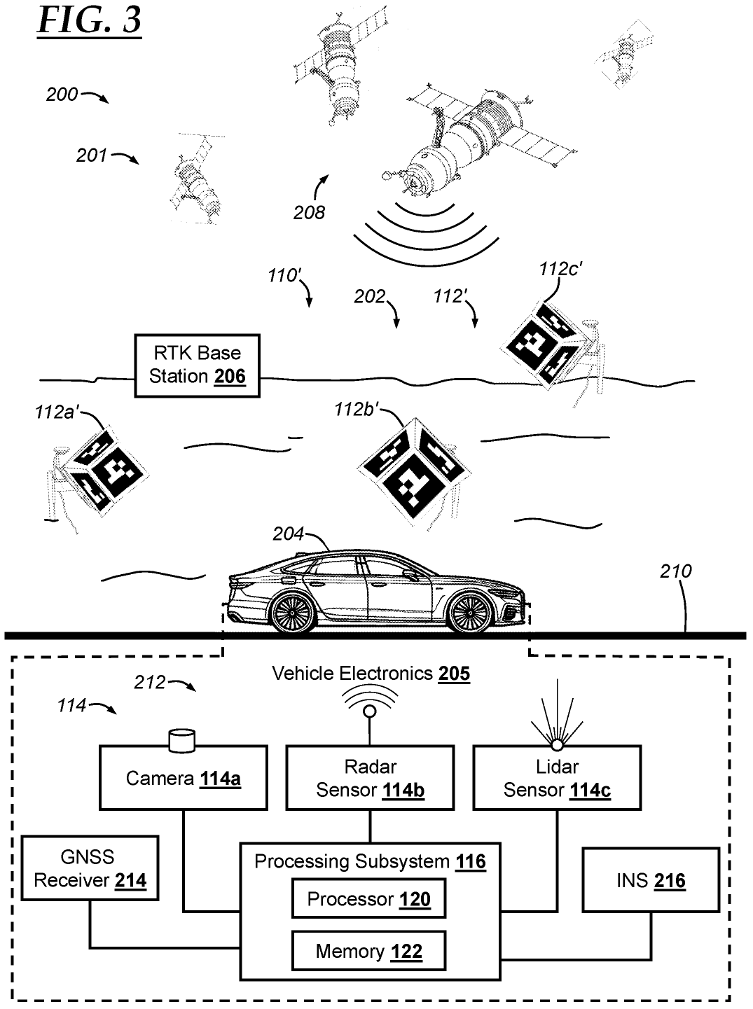

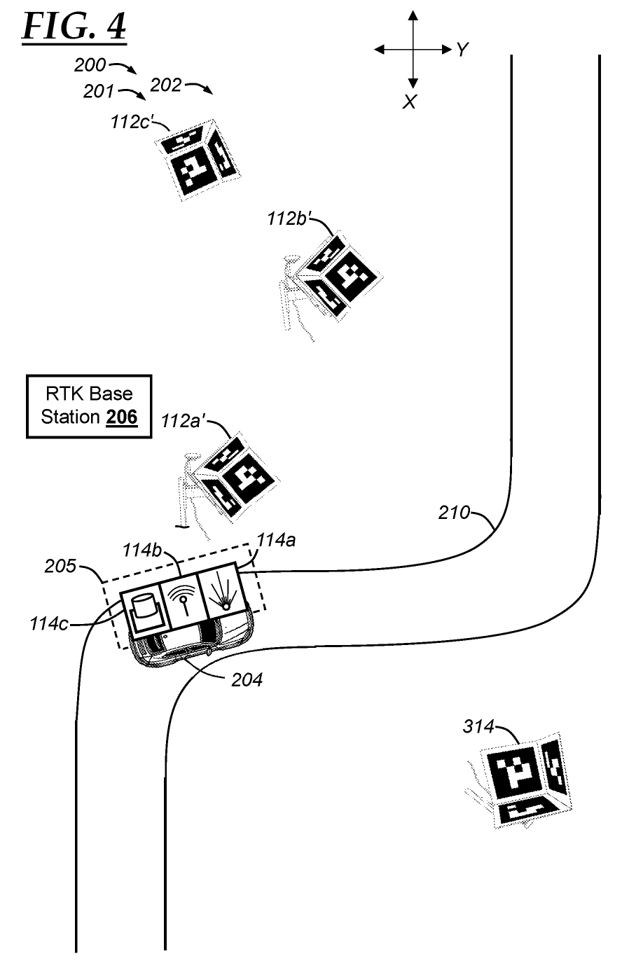

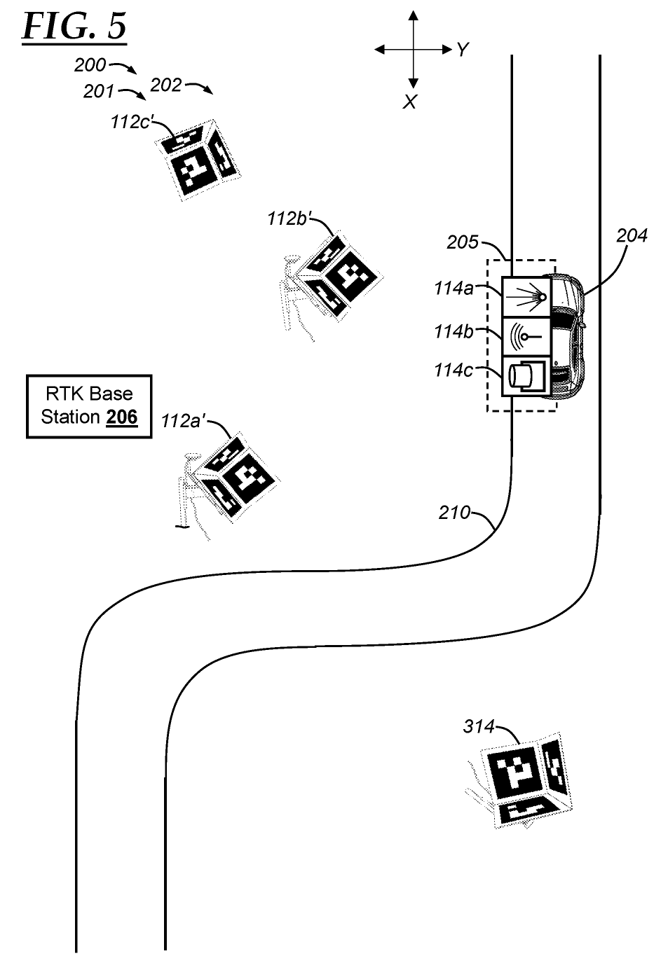

With reference to FIGS. 3-5, there is shown a multi-sensor extrinsic calibration environment 200; in particular, FIG. 3 depicts a diagrammatic isometric view of the multi-sensor extrinsic calibration environment 200, and FIGS. 4-5 each depict a top-down, plan, diagrammatic view (in the X-Y plane as depicted, considered level to earth/perpendicular to gravity) of the multi-sensor extrinsic calibration environment 200 of FIG. 3. The present embodiment teaches a multi-sensor extrinsic calibration framework 201 for performing extrinsic calibration for calibratable sensors carried by a mobile sensor platform; particularly, FIG. 4 illustrates a top-down, plan, diagrammatic view of the multi-sensor extrinsic calibration framework 201 at a first time whereat the mobile sensor platform is at a first location and first orientation, and FIG. 5 illustrates a top-down, plan, diagrammatic view of the multi-sensor extrinsic calibration framework 201 at a second time whereat the mobile sensor platform is at a second location and second orientation. Although the extrinsic calibration framework 201 includes a mobile sensor platform, in other embodiments, a stationary or fixed sensor platform is used and its calibratable sensors calibrated.

The multi-sensor extrinsic calibration environment 200 includes a local calibration area 202, a vehicle 204 having vehicle electronics 205 and being disposed at the local calibration area 202, a real-time kinematic (RTK) base station 206, and a constellation of GNNS satellites 208 for providing GNSS signals. The multi-sensor extrinsic calibration environment 200 is illustrated in FIG. 3 as also including a multi-sensor extrinsic calibration system 110', which is akin to the multi-sensor extrinsic calibration system 110 of FIG. 2 discussed above, the discussion of which is hereby incorporated and attributed to the multi-sensor extrinsic calibration system 110' to the extent that discussion is not inconsistent with the discussion of the multi-sensor extrinsic calibration system 110'.

The multi-sensor extrinsic calibration system 110' includes a plurality of fiducial targets 112' arranged within the local calibration area 202. The rectilinear dashed lines of FIG. 3 and the vehicle 204 to which they connect together surround components of the vehicle 204 that are included in its vehicle electronics 205, which include an onboard multi-sensor extrinsic calibration processing system 212. The onboard multi-sensor extrinsic calibration processing system 212 includes the plurality of calibratable sensors 114 (including the camera 114a, the radar sensor 114b, and the lidar sensor 114c) as well as the processing subsystem 116. Also, in the illustrated embodiment, the onboard multi-sensor extrinsic calibration processing system 212 further includes a GNSS receiver 214, which is used for obtaining a position and/or orientation of the vehicle 204, as well as an inertial navigation system (INS) 216, which is used, at in least in one embodiment, for providing precise measurements of the vehicle’s movements, such as acceleration and angular velocity, to assist in accurately determining the vehicle’s position and orientation during the calibration process.

The local calibration area 202 includes an area or region having the calibratable sensors 114 and the fiducial targets 112. Herein, a local calibration area, when used in connection with calibratable sensors and fiducial target(s) for calibrating said calibratable sensors, refers to area or region at which the fiducial target(s) are located and at which sensor data of the fiducial target(s) is captured by the sensors. In the present embodiment, the local calibration area 202 is shown as including a portion of ground nearby a road 210 on which the vehicle 204 is travelling. For example, in FIG. 3, in the local calibration area 202, three fiducial targets 112a-c' are shown as being disposed over ground proximate the road 210 on which the vehicle 204 is travelling.

With specific reference now to FIGS. 4-5, the vehicle 204 is shown as travelling along the road 210 through the local calibration area 202, proceeding along the road according to a trajectory beginning generally at the bottom of each respective figure and ending generally at the top of each respective figure. FIG. 4 illustrates the multi-sensor extrinsic calibration environment 200 at a first time whereat the vehicle 204 is located at a first location and oriented at a first orientation; the first location and the first orientation are collectively referred to as the first calibration position. FIG. 5 illustrates the multi-sensor extrinsic calibration environment 200 at a second time whereat the vehicle 204 is located at a second location and oriented at a second orientation; the second location and the second orientation are collectively referred to as the second calibration position.

With reference again generally to FIGS. 3-5, the vehicle 204 is shown as being an automobile, particularly, a sedan; however, it will be appreciated that a variety of different vehicles 204 may be used as the sensor platform for the plurality of sensors 114, including other land vehicles, aircraft including passenger aircraft and unmanned aerial vehicles (UAVs), boats, ships, and other marine vessels, etc. Likewise, the local calibration area 202 may be adapted or suited for the vehicle or sensor platform to have the calibratable sensors (the sensors 114); for example, in the case the sensor platform is a boat or other marine vessel, the local calibration area 202 may comprise open sea or body of water over which the one or more fiducial targets 112' are disposed.

In other embodiments, the sensor platform having the calibratable sensors is not mobile, but is fixed, such as a particular location whereat the sensor platform is fixed to the ground or otherwise fixed in place relative to earth’s surface.

The onboard multi-sensor extrinsic calibration processing system 212 includes the GNSS receiver 214 and the INS 216. The GNSS receiver 214 is analogous to the GNSS receivers discussed above in connection with the GNSS antennas 124a,b, except that the GNSS receiver 214 is carried with the vehicle electronics 205 as an onboard device capable of determining a position of the vehicle on earth through receiving GNSS signals from the constellation of GNSS satellites 208. The discussion of aspects of the GNSS receivers for the GNSS antennas 124a,b discussed above is hereby incorporated and attributed to the GNSS receiver 214 to the extent such discussion is not inconsistent with the discussion of the GNSS receiver 214.

The INS 216 is used to provide data regarding the vehicle’s dynamic behavior, particularly its physical movement, including acceleration and angular velocity, which aids in the accurate positioning (location and orientation) of the vehicle 204. This INS information is useful for the multi-sensor extrinsic calibration processing system 212 for correctly aligning and calibrating the various sensors (e.g., the calibratable sensors 114) onboard the vehicle. In embodiments, the data from the INS 216 is used to ensure that the calibratable sensors 114 are accurately calibrated relative to each other and the vehicle’s coordinate system, leading to improved performance and reliability of the vehicle’s sensor-based systems, particularly, for example, those used for AV operations, such as AV trajectory determination and planning.

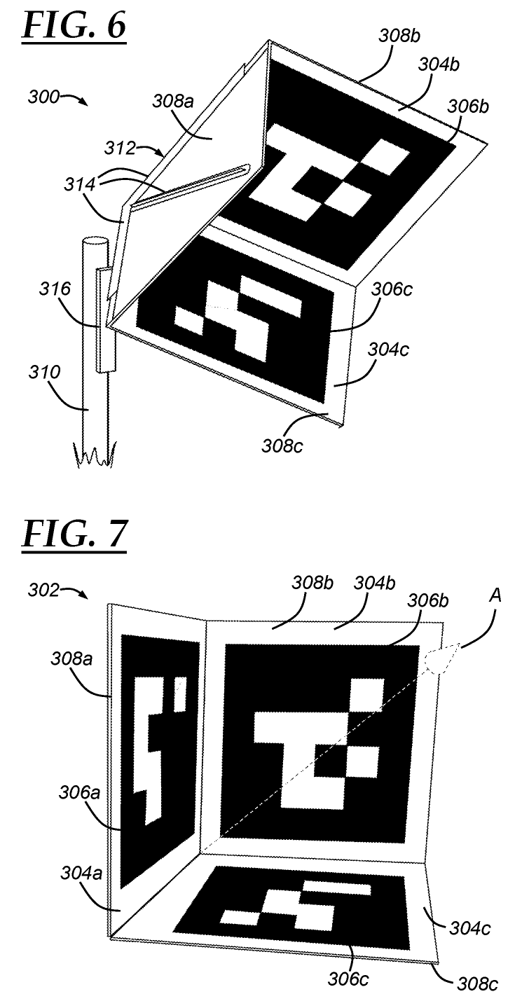

With reference now to FIGS. 6 and 7, there is shown an embodiment of a fiducial target 300 (FIG. 6) and a sensor return portion 302 of the fiducial target (FIG. 7). In particular, the illustrated embodiment depicts a sensor return portion 302 comprised of three orthogonal surfaces 304a-c, each surface 304a-c being oriented orthogonally relative to the other two surfaces 304a-c and comprising a visual indicator 306a-c depicted on the surface 304a-c. The rectilinearity and cornered abutment of the surfaces 304a-c realizes a corner of a virtual cube; accordingly, such configuration of surfaces is referred to as a cube corner sensor return portion as the three surfaces 304a-c together resemble a corner of a virtual cube due to their rectilinearity and abutment. It will be appreciated that the three surfaces 304a-c may not actually come into abutment with one another and, indeed (at least in some embodiments), is spaced apart at a relatively minor spacing (i.e., a spacing of no more than 25% of the length of the respective surface 304a-c as measured in the direction of the spacing and within the same plane as the respective surface 304a-c); however, even in such embodiments employing minor spacing, the surfaces within such embodiments still are considered to constitute a cube corner sensor return portion. When two surfaces are spaced apart, a virtual plane extending in the same plane as each respective surface of the two surfaces extends and at some line, intersects the other one of the two surfaces or other virtual plane if the other surface is spaced away from this plane as well.

In the depicted embodiment of FIG. 7, a sensor return axis A is defined as the axis that extends from the vertex of the cube of the corner (or virtual corner) formed by the three orthogonal surfaces and along a line that is disposed forty five degrees (45°) relative to each of the three orthogonal surfaces. This sensor return axis A extends along a body diagonal of the virtual cube. The sensor return axis A is angled toward a calibration position, such as a road over which a vehicle or other mobile sensor platform having the calibratable sensor travels.

The sensor return portion 302 is comprised of the three surfaces 304a-c, each of which is a surface of a planar sensor return panel 308a-c. Each of the planar sensor return panels 308a-c may be comprised of any suitable solid material, such as metal or plastic. The planar sensor return panels 308a-c each include a visual indicator 306a-c on each’s respective surface 304a-c. The visual indicator 306a-c is a two-dimensional barcode consisting of a high-contrast (e.g., black and white) code. Each visual indicator 306a-c spans a large portion (i.e., over 66%) of the surface 304a-c on which it is disposed. The visual indicator 306a-c is in the form of an AprilTag™ in the depicted embodiments. However, it will be appreciated that, in other embodiments, other visual indicators detectable by the calibratable sensor(s) to be calibrated are used as the visual indicators 306a-c.

In the present embodiment, each of the planar sensor return panels 308a-c abut one another so as to form a shape resembling a corner of a virtual cube, as discussed above. In one embodiment, the sensor return portion 302 is unitary in construction in that the same piece of material is used for forming each and all of the planar sensor return panels 308a-c. For example, the sensor return portion 302 may be formed from a plastic material and, in such embodiments, may be of a unitary construction in which a three-surfaced plastic piece is manufactured and includes the planar sensor return panels 308a-c. In other embodiments, multiple different pieces and/or materials may be used for forming the sensor return portion 302. For example, where the planar sensor return panels 308a-c are comprised of a metal material, the planar sensor return panels 308a-c may each be a metal sheet and may be welded or otherwise joined to the other metal sensor return panels.

In at least one embodiment, such as where the calibratable sensors are to be used for a vehicle (e.g., lidar, radar, camera) for assisting the vehicle with determining aspects of its environment, the planar sensor return panels 308a-c are sized in a manner that supports and enables suitable calibration for each of the particular calibratable sensors. In the present embodiment, for example, each of the planar sensor return panels 308a-c has an area of at least three square feet; and, in another embodiment, each of the planar sensor return panels 308a-c has an area of at least one square foot. Additionally, or alternatively, each of the planar sensor return panels 308a-c has an area that is no larger than nine square feet and, in one embodiment, no larger than seven square feet.

In embodiments, the visual indicator 306a-c is sized to cover at least 75% of the surface area of the corresponding planar sensor return panel 308a-c on which it is disposed; in other embodiments, the visual indicator 306a-c is sized to cover at least 90% of the surface area of the corresponding planar sensor return panel 308a-c on which it is disposed.

The sensor return portion 302 is attached to a post 310 via a mounting bracket 312 that is used for fixing the sensor return portion 302 to the ground or other fixed object, such as a telephone pole, traffic signal, streetlight, building, etc. In the embodiment of FIG. 6, the post 310 is inserted into and fixed to the ground. The post 310 is connected to the mounting bracket 312, and the mounting bracket 312 then is connected to a rear surface of each of the planar sensor return panels 308a-c via arms 314 that extend from the mounting bracket base 316. The post 310, the mounting bracket 312, and the planar sensor return panels 308a-c may be connected to one another via any suitable means, including, for example, screws or bolts, glues or adhesives, welds or weldments, press connectors or other resilient locking means, etc.

Furthermore, the sensor return portion 302 may be sized suitably for the particular sensors that will be used. In embodiments, each of the three surfaces 304a-c of the sensor return portion 302 is at least one square foot in area, such as a one foot by one-foot square surface; and, in one embodiment, each of the three surfaces 304a-c is at least three square feet in area. Such sizing is appropriate for various types of calibratable sensors, including camera, radar, and lidar sensors, for example, as used in AV applications.

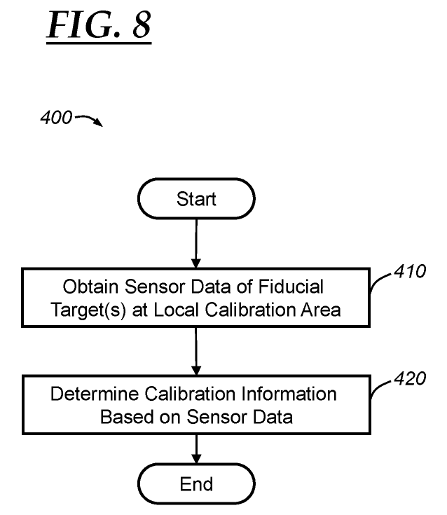

With reference to FIG. 8, there is shown an embodiment of a method 400 for obtaining calibration information for one or more calibratable sensors as a result of extrinsic calibration using a fiducial target. The method 400 is performed by the system multi-sensor extrinsic calibration system 10, or any embodiment thereof discussed herein, including the multi-sensor extrinsic calibration system 110 and/or multi-sensor extrinsic calibration system 110'.

The method 400 begins with step 410, wherein sensor data pertaining to at least one of the one or more fiducial targets is obtained from each of two or more calibratable sensors of a different sensor type. For example, with reference to FIGS. 3-4, the camera 114a, the radar sensor 114b, and the lidar sensor 114c capture sensor data of the fiducial target 112a' at the same time (and potentially fiducial target 112c' depending on particular field of view of the sensors 114). And, as another example, with reference to FIGS. 3 and 5, the camera 114a, the radar sensor 114b, and the lidar sensor 114c capture sensor data of the fiducial targets 112a (and potentially fiducial target 112a' depending on particular field of view of the sensors 114). The sensor data of each of the three sensors 114 is then stored in memory, such as the memory 112 or other memory of the vehicle electronics 205. The method 400 continues to step 420.

In step 420, calibration information is determined based on the sensor data from the two or more calibratable sensors. At least in one embodiment, this involves processing the collected sensor data to extract relevant features and comparing these features against the known characteristics of the fiducial targets. For example, the processing subsystem 116 utilizes algorithms to calculate the relative positions and orientations of the sensors with respect to each other and the fiducial targets 112,112'. This may include performing transformations and optimizations to align the sensor data accurately, accounting for any discrepancies due to sensor noise or environmental factors. The result is a set of calibration parameters that define the spatial relationships between the sensors, ensuring that their sensor data or information captured during the sensors intended operation can be accurately fused and interpreted within a common coordinate system or reference plane. These calibration parameters may then be stored in memory for use in subsequent sensor data processing and AV operations. The method 400 ends.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. A multi-sensor extrinsic calibration system, comprising:
one or more fiducial targets, wherein each fiducial target of the one or more fiducial targets has a sensor return portion comprised of three orthogonal surfaces, and wherein each orthogonal surface of the three orthogonal surfaces is orthogonal to both other orthogonal surfaces and displays a visual indicator configured to be detected by at least one of the two or more calibratable sensors; and
a processing subsystem comprised of at least one processor and memory storing computer instructions;
wherein the processing subsystem, when executing the computer instruction using the at least one processor, causes the multi-sensor extrinsic calibration system to:
obtain sensor data pertaining to at least one of the one or more fiducial targets from each of two or more calibratable sensors of a different sensor type; and
determine calibration information based on the sensor data from the two or more calibratable sensors.

2. The multi-sensor extrinsic calibration system of claim 1, wherein each orthogonal surface of the three orthogonal surfaces is coupled to both other orthogonal surfaces.

3. The multi-sensor extrinsic calibration system of claim 2, wherein the two orthogonal surfaces all are coupled to each other so as to form a common corner whereat the three orthogonal surfaces meet.

4. The multi-sensor extrinsic calibration system of claim 1, wherein the two or more calibratable sensors include a camera and at least one of a lidar unit and a radar unit.

5. The multi-sensor extrinsic calibration system of claim 1, wherein the two or more calibratable sensors include at least three sensors, and wherein the at least three sensors include a camera, a lidar unit, and a radar unit.

6. The multi-sensor extrinsic calibration system of claim 1, wherein the at least one fiducial target is oriented so as to face a sensor capture location for a mobile platform carrying the three calibratable sensors.

7. The multi-sensor extrinsic calibration system of claim 6, wherein the three orthogonal surfaces form a corner of a virtual cube, and wherein the at least one fiducial target is oriented so that a vector originating from the corner and extending along a body diagonal of the virtual cube is directed toward the sensor capture location for the mobile platform.

8. The multi-sensor extrinsic calibration system of claim 1, wherein, for each fiducial target of the one or more fiducial targets, the visual indicator of each of the three orthogonal surfaces is different than the visual indicator of both other orthogonal surfaces of the fiducial target.

9. The multi-sensor extrinsic calibration system of claim 1, wherein the sensor data from each calibratable sensor of the two or more calibratable sensors is captured simultaneously.

10. The multi-sensor extrinsic calibration system of claim 1, wherein the calibration information is used for performing extrinsic calibration for the two or more calibratable sensors.

11. The multi-sensor extrinsic calibration system of claim 1, wherein each calibratable sensor of the two or more calibratable sensors is configured to capture sensor information used as a part of a multi-modal sensor system.

12. The multi-sensor extrinsic calibration system of claim 11, wherein the two or more calibratable sensors and the multi-modal sensor system are carried by an autonomous vehicle, other vehicle, or other mobile sensor platform.

13. The multi-sensor extrinsic calibration system of claim 11, wherein the multi-modal sensor system is configured to fuse the sensor data from the two or more calibratable sensors.

14. The multi-sensor extrinsic calibration system of claim 1, wherein the two or more calibratable sensors have an overlapping field of view and are configured to capture data simultaneously.

15. The multi-sensor extrinsic calibration system of claim 1, wherein the visual indicator is configured to be detected by each of the two or more calibratable sensors.

16. A method of obtaining calibration information for one or more calibratable sensors as a result of extrinsic calibration using a fiducial target, wherein the fiducial target has a sensor return portion comprised of three orthogonal surfaces, wherein each orthogonal surface of the three orthogonal surfaces is orthogonal to both other orthogonal surfaces and displays a visual indicator configured to be detected by at least one of the two or more calibratable sensor, and wherein the method comprises:
obtaining sensor data pertaining to at least one of the one or more fiducial targets from each of two or more calibratable sensors of a different sensor type; and
determining calibration information based on the sensor data from the two or more calibratable sensors.

17. A fiducial target for use in extrinsic calibration of two or more calibratable sensors, comprising: a sensor return portion comprised of three orthogonal surfaces, wherein each orthogonal surface of the three orthogonal surfaces is orthogonal to both other orthogonal surfaces and displays a visual indicator configured to be detected by at least one of the two or more calibratable sensors.

18. The fiducial target of claim 17, wherein the visual indicator is an AprilTag, quick-response (QR) code, or other graphic whose orientation is detectable.

19. The fiducial target of claim 17, wherein each orthogonal surface of the three orthogonal surfaces is coupled to both other orthogonal surfaces.

20. The fiducial target of claim 19, wherein the two orthogonal surfaces all are coupled to each other so as to form a common corner whereat the three orthogonal surfaces meet.

21. The fiducial target of claim 17, further comprising a global navigation satellite system (GNSS) antenna co-located with the sensor return portion at least during an initial position measurement operation.

22. The fiducial target of claim 17, wherein the surface area of each surface of the three or more orthogonal surfaces is at least one square foot.

23. The fiducial target of claim 17, wherein the surface area of each surface of the three or more orthogonal surfaces is at least three square feet.
